(19) United States
(12) Patent Application Publication
(10) Pub. No.: US 2024/0394446 A1
(43) Pub. Date: Nov. 28, 2024

(54) TRAINING MODEL CREATING METHOD, LASER DEVICE, AND ELECTRONIC DEVICE MANUFACTURING METHOD

(71) Applicant: Gigaphoton Inc., Tochigi (JP)

(72) Inventors: Norimasa FUJITA, Oyama-shi (JP); Kunihiko ABE, Oyama-shi (JP)

(73) Assignee: Gigaphoton Inc., Tochigi (JP)

(21) Appl. No.: 18/797,559

(22) Filed: Aug. 8, 2024

Related U.S. Application Data
(63) Continuation of application No. PCT/JP2022/010860, filed on Mar. 11, 2022.

(51) Int. Cl. G06F 30/27; G06F 119/02; G06F 119/18

(52) U.S. Cl. CPC G06F 30/27; G06F 2119/02; G06F 2119/18

(57) ABSTRACT

A training model creating method includes creating a database by breaking a component in a laser device on a Digital Twin constructed by modeling electrical hardware and software of the laser device, and accumulating data in which the broken component and a failure phenomenon output from the Digital Twin are associated with each other; and training a training model using the data in the database as training data for machine learning so that, upon receiving an input of information on a failure phenomenon, the training model outputs information on a malfunction location corresponding to the input.

### CROSS-REFERENCE TO RELATED APPLICATIONS

The present application claims the benefit of International Application No. PCT/JP2022/010860, filed on Mar. 11, 2022, the entire contents of which are hereby incorporated by reference.

### BACKGROUND

### 1. Technical Field

The present disclosure relates to a training model creating method, a laser device, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 μm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectral line width. In the following, a gas laser device with a narrowed spectral line width is referred to as a line narrowing gas laser device.

### LIST OF DOCUMENTS

### Patent Documents

Patent Document 1: U.S. Pat. No. 10,990,089
Patent Document 2: Japanese Patent Application No. 2020-177276
Patent Document 3: US Patent Application No. 2020/0103842

### SUMMARY

A training model creating method according to an aspect of the present disclosure includes creating a database by breaking a component in a laser device on a Digital Twin constructed by modeling electrical hardware and software of the laser device, and accumulating data in which the broken component and a failure phenomenon output from the Digital Twin are associated with each other; and training a training model using the data in the database as training data for machine learning so that, upon receiving an input of information on a failure phenomenon, the training model outputs information on a malfunction location corresponding to the input.

A laser device according to another aspect of the present disclosure includes an electrical hardware including a processor, a monitoring target including a sensor, a state of which is to be monitored by the processor, and equipment including a wiring for connecting the processor and the monitoring target; and a training model trained by machine learning to output, upon receiving an input of information on a failure phenomenon, information on a malfunction location corresponding to the input. Here, the training model is a model trained using data, as training data, in a database created by breaking a component in the laser device on a Digital Twin constructed by modeling the electrical hardware and software of the laser device and accumulating the data in which the broken component and a failure phenomenon output from the Digital Twin are associated with each other.

An electronic device manufacturing method according to another aspect of the present disclosure includes generating laser light using a laser device, outputting the laser light to an exposure apparatus, and exposing a photosensitive substrate to the laser light in the exposure apparatus to manufacture an electronic device. Here, the laser device includes an electrical hardware including a processor, a monitoring target including a sensor, a state of which is to be monitored by the processor, and equipment including a wiring for connecting the processor and the monitoring target; and a training model trained by machine learning to output, upon receiving an input of information on a failure phenomenon, information on a malfunction location corresponding to the input. The training model is a model trained using data, as training data, in a database created by breaking a component in the laser device on a Digital Twin constructed by modeling the electrical hardware and software of the laser device and accumulating the data in which the broken component and a failure phenomenon output from the Digital Twin are associated with each other.

### BRIEF DESCRIPTION OF THE DRAWINGS

Embodiments of the present disclosure will be described below merely as examples with reference to the accompanying drawings.

FIG. 1 schematically shows an exemplary configuration of a laser device.

FIG. 2 schematically shows the configuration for notifying error information based on information obtained from a monitor module.

FIG. 3 schematically shows how a service engineer deals with a failure phenomenon of a laser device.

FIG. 4 is an explanatory diagram showing an outline of a system that implements a training model creating method according to a first embodiment.

FIG. 5 is a table showing an example of data accumulated in a database.

FIG. 6 is an explanatory diagram schematically showing an example of a method of using a trained model created by implementing the training model creating method according to the first embodiment.

FIG. 7 is a table showing an example of an estimation list of a malfunction location estimated using the training model.

FIG. 8 is an explanatory diagram showing an outline of a training model creating method according to a second embodiment.

FIG. 9 is an explanatory diagram showing laser devices each including the training model according to a third embodiment and an outline of an application example thereof.

FIG. 10 schematically shows a configuration example of an exposure apparatus.

### DESCRIPTION OF EMBODIMENTS

### <Contents>

1. Overview of Laser Device
   1.1 Configuration
   1.2 Operation
   1.3 Example of notification of error information
   1.4 Problem
2. First Embodiment
   2.1 Configuration
   2.2 Operation
      2.2.1 Generation of training data and training phase
      2.2.2 Inference phase
   2.3 Effect
3. Second Embodiment
   3.1 Configuration
   3.2 Operation
   3.3 Effect
4. Third Embodiment
   4.1 Configuration
   4.2 Operation
   4.3 Effect
5. Other examples of laser device
6. Functional role of information processing system
7. Electronic device manufacturing method
8. Others

Hereinafter, embodiments of the present disclosure will be described in detail with reference to the drawings. The embodiment described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Overview of Laser Device

### 1.1 Configuration

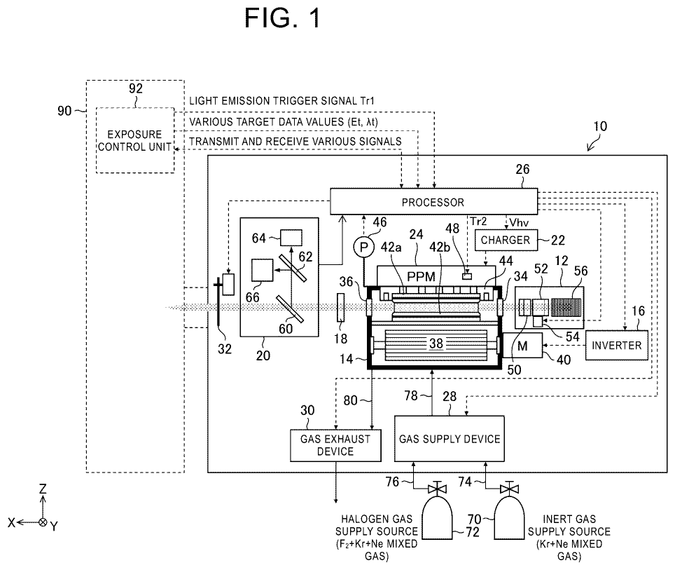

FIG. 1 schematically shows an exemplary configuration of a laser device 10. The laser device 10 is a KrF excimer laser device, and includes a line narrowing module (LNM) 12, a chamber 14, an inverter 16, a front mirror (output coupling mirror) 18, a monitor module 20, a charger 22, a pulse power module (PPM) 24, a processor 26, a gas supply device 28, a gas exhaust device 30, and an outlet port shutter 32.

The chamber 14 includes windows 34, 36, a cross flow fan (CFF) 38, a motor 40 for rotating the CFF 38, a pair of electrodes 42a, 42b, an electric insulator 44, a pressure sensor 46, and a heat exchanger (not shown).

The PPM 24 is connected to the electrode 42a via a feedthrough in the electric insulator 44 of the chamber 14. The PPM 24 includes a semiconductor switch 48, a charging capacitor (not shown), a pulse transformer (not shown), and a pulse compression circuit (not shown).

The front mirror 18 is a partial reflection mirror and is arranged to configure an optical resonator together with the LNM 12. The chamber 14 is arranged on the optical path of the optical resonator. The LNM 12 includes a beam expander configured of two prisms 50, 52, a rotation stage 54, and a grating 56. The prisms 50, 52 are arranged to expand the beam of light output from the window 34 of the chamber 14 in a Y direction and to cause the light to be incident on the grating 56.

The grating 56 is arranged in the Littrow arrangement so that the incident angle and the diffraction angle of the laser light coincide with each other. Further, the prism 52 is arranged on the rotation stage 54 such that the incident angle and the diffraction angle of the laser light on the grating 56 change when the rotation stage 54 rotates.

The monitor module 20 includes beam splitters 60, 62, a pulse energy detector 64, and a spectrum detector 66. The beam splitter 60 is arranged on the optical path of the laser light output from the front mirror 18 so as to reflect a part of the laser light incident thereon to be incident on the beam splitter 62.

The pulse energy detector 64 is arranged so that the laser light transmitted through the beam splitter 62 is incident thereon. The pulse energy detector 64 may be, for example, a photodiode that measures the light intensity of ultraviolet rays. The beam splitter 62 is arranged so that a part of the laser light incident thereon is reflected to enter the spectrum detector 66. The spectrum detector 66 is, for example, a monitor etalon measurement device that measures interference fringes generated by an etalon with an image sensor. The center wavelength and the spectral line width of the laser light are measured based on the generated interference fringes.

The gas supply device 28 is connected to an inert gas supply source 70 which is a supply source of an inert laser gas and a halogen gas supply source 72 which is a supply source of a laser gas containing halogen gas via pipes 74, 76, respectively. In the case of the KrF excimer laser device, the inert laser gas is a mixed gas of a Kr gas and an Ne gas, and the laser gas containing a halogen gas is a mixed gas of an F: gas, a Kr gas, and an Ne gas. The gas supply device 28 is connected to the chamber 14 via a pipe 78. The gas supply device 28 includes an automatic valve (not shown) and a mass flow controller (not shown) for supplying a predetermined amount of each of the inert laser gas and the laser gas containing halogen to the chamber 14.

The gas exhaust device 30 is connected to the chamber 14 via a pipe 80, and includes a halogen filter (not shown) for removing halogen and an exhaust pump (not shown), and is configured to exhaust the laser gas from which halogen is removed to the outside.

The outlet port shutter 32 is arranged on the optical path of the laser light output from the laser device 10 to the outside.

The inverter 16 is a power supply device for the motor 40 that drives the CFF 38 and is configured to receive, from the processor 26, the frequency of the power supplied to the motor 40. The processor 26 in the present disclosure is a processing device including a storage device in which a control program is stored and a central processing unit (CPU) that executes the control program. The processor 26 is specifically configured or programmed to perform various processes included in the present disclosure. The processor 26 is electrically connected to a plurality of configurations of the laser device 10, and is configured to communicate with them and to control them. The configurations connected to the processor 26 include unillustrated configurations as well. The processor 26 is also connected to an exposure apparatus 90.

### 1.2 Operation

After causing the gas exhaust device 30 to exhaust the gas in the chamber 14, the processor 26 causes the gas supply device 28 to fill the chamber 14 with the laser gas so that the mixed gas of Kr and Ne and the mixed gas of F₂, Kr, and Ne provide a desired gas composition and a desired total gas pressure.

The processor 26 causes, via the inverter 16, the motor 40 to rotate at a predetermined number of revolution so that the CFF 38 is rotated. As a result, the laser gas flows between the electrodes 42a, 42b. The processor 26 receives a target pulse energy Et from an exposure control unit 92 of the exposure apparatus 90, and transmits data of a charge voltage Vhv to the charger 22 so that the pulse energy becomes Et. The charger 22 charges the charging capacitor of the PPM 24 so that the charge voltage Vhv is acquired.

When a light emission trigger signal Tr1 is output from the exposure apparatus 90, a trigger signal Tr2 is input from the processor 26 to the semiconductor switch 48 of the PPM 24 in synchronization with the light emission trigger signal Tr1. When the semiconductor switch 48 is operated, a current flows from the charging capacitor of the PPM 24, pulse compression is performed by a magnetic compression circuit, and a high voltage is applied between the electrodes 42a, 42b. As a result, discharge occurs between the electrodes 42a, 42b, and the laser gas is excited in a discharge space.

Excimer light is generated when the excited laser gas in the discharge space reaches the ground state. The excimer light reciprocates between the front mirror 18 and the LNM 12 and is amplified, thereby causing laser oscillation. As a result, the pulse laser light having line-narrowed is output from the front mirror 18. The pulse laser light output from the front mirror 18 enters the monitor module 20.

In the monitor module 20, a part of the pulse laser light is sampled by the beam splitter 60 to enter the pulse energy detector 64 or the spectrum detector 66 via the beam splitter 62. The pulse energy detector 64 measures the pulse energy E of the pulse laser light and transmits data thereof to the processor 26. The spectrum detector 66 measures a center wavelength λ and a spectral line width ΔΔ of the pulse laser light and transmits data thereof to the processor 26.

The processor 26 receives the target pulse energy Et and a target wavelength λt from the exposure apparatus 90. The processor 26 performs various types of control including control of the pulse energy and control of the wavelength. In the control of the pulse energy, the charge voltage Vhv is controlled such that a difference ΔE between the pulse energy E measured by the pulse energy detector 64 and the target pulse energy Et approaches 0. In the control of the wavelength, the rotation angle of the rotation stage 54 is controlled such that a difference δλ between the center wavelength λ measured by the spectrum detector 66 and the target wavelength λt approaches 0.

As described above, the processor 26 receives the target pulse energy Et and the target wavelength λt from the exposure apparatus 90, and causes the pulse laser light to be output in synchronization with the light emission trigger signal Tr1 each time the light emission trigger signal Tr1 is input.

When the laser device 10 repeats discharge, the electrodes 42a, 42b are worn, the halogen gas in the laser gas is consumed, and an impurity gas is generated. The decrease in the halogen gas concentration and the increase of the impurity gas in the chamber 14 cause a decrease in the pulse energy E of the pulse laser light and the stability of the pulse energy is adversely affected. The processor 26 executes the following gas control ([1]˜[3]) in order to suppress these adverse effects.

### [1] Halogen Injection Control

The halogen injection control is gas control in which, during laser oscillation, the halogen gas consumed mainly by discharge in the chamber 14 is replenished by injecting a gas containing a halogen gas having a higher concentration than the halogen gas in the chamber 14.

### [2] Partial Gas Exchange Control

The partial gas exchange control is gas control in which, during laser oscillation, a part of the laser gas in the chamber 14 is exchanged with a new laser gas so as to suppress an increase in the concentration of the impurity gas in the chamber 14.

### [3] Gas Pressure Control

The gas pressure control is gas control in which the pulse energy E is controlled by injecting the laser gas into the chamber 14 to change the total pressure of the laser gas when it is difficult to overcome, within a control range of the charge voltage Vhv, a decrease in the pulse energy E of the pulse laser light output from the laser device 10.

When the laser gas is exhausted from the chamber 14, the processor 26 controls the gas exhaust device 30. The halogen gas is removed from the laser gas exhausted from the chamber 14 by a halogen filter, and the laser gas is exhausted to the outside of the laser device 10.

The processor 26 transmits data of parameters such as the number of oscillation pulses, the charge voltage Vhv, a gas pressure Pch in the chamber 14, and the pulse energy E of the laser light to a laser device management system (not shown).

### 1.3 Example of Notification of Error Information

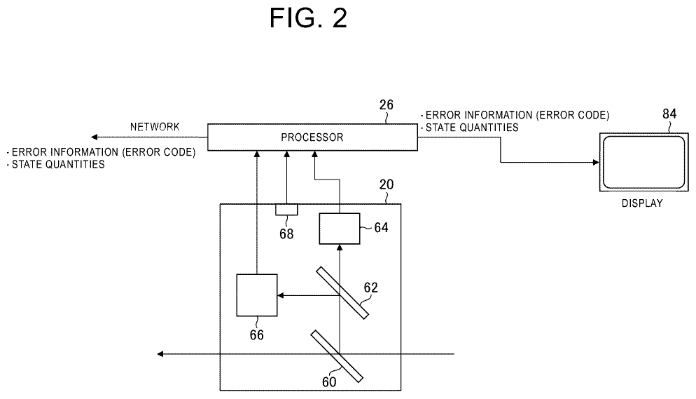

FIG. 2 schematically shows the configuration for notifying error information based on information obtained from the monitor module 20. The laser device 10 may output information from a plurality of sensors to a display 84 or a computer network. For example, the pulse energy detector 64, the spectrum detector 66, and a temperature sensor 68 that measures the temperature in the monitor module 20, of the monitor module 20, are connected to the processor 26. The processor 26 may monitor state quantities of these sensors, and when an abnormal value is detected, the processor 26 may output a corresponding error code or each state quantity.

Other modules and equipment of the laser device 10 are similarly connected to the processor 26 and their operation are monitored by the processor 26.

Various sensors connected to the processor 26 to monitor the state quantity, signal lines, interfaces, and relay devices which electrically connect the various sensors to the processor 26, and electrical and electronic elements included in the processor 26 are collectively referred to as electrical hardware.

The electrical hardware is configured of the processor 26, monitoring targets in the laser device 10 including sensors, states of which are to be monitored by the processor 26, and equipment including wirings for connecting the processor 26 and the monitoring targets. Accordingly, the electrical hardware also includes an actuator with an encoder, a proximity switch, an Ethernet repeater, a sequencer, an AD converter, a DA converter, a programmable controller, and the like.

### 1.4 Problem

When the processor 26 detects an abnormality in the output from a module, a sensor, or the like under monitoring, the processor 26 notifies a service engineer FSE of an error or a state quantity with the display 84 or the like. Depending on the location of a malfunction or a failure, a plurality of errors and state quantities are displayed, and there is a case in which causes thereof are not easy to be identified.

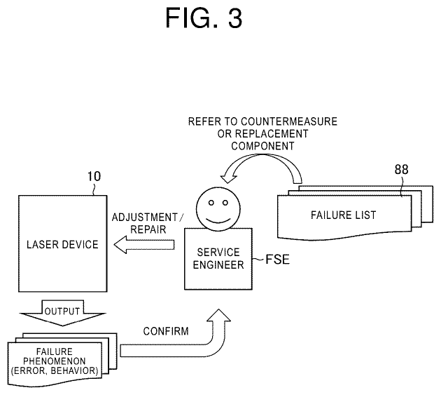

In such a case, the service engineer FSE compares the error and abnormal behavior of the laser device 10 with a failure list 88 that summarizes failure phenomena that have occurred in the past, examines and determines a countermeasure or a replacement component, and performs adjustment, repair, or the like (see FIG. 3). The failure list 88 is a list of causes of failures and/or replacement components corresponding to errors and state quantities that have occurred in the past. Here, replacement of a component is included in the concept of “repair.” “Replacement” of a component includes replacing a component with a new one, as well as maintaining and/or recovering the function of a component by performing cleaning or the like on the component and repositioning the same component.

FIG. 3 schematically shows how the service engineer FSE deals with a failure phenomenon of the laser device 10. The service engineer FSE confirms the failure phenomenon such as an error code and abnormal behavior of the laser device 10 notified by the display 84 or the like, and when identification of the cause or the like is difficult, refers to a countermeasure or a replacement component in the failure list 88, and performs adjustment or repair of equipment, a component, or the like.

Therefore, when a new failure that is not included in the failure list 88 occurs, a countermeasure may not be clear. In this case, partial operation or acquisition of specific data is forced for specifying a malfunction location, and a long working time is required. When a malfunction location can still not be identified, a member of a development department needs to investigate the actual machine, which takes time to solve the problem.

### 2. First Embodiment

### 2.1 Configuration

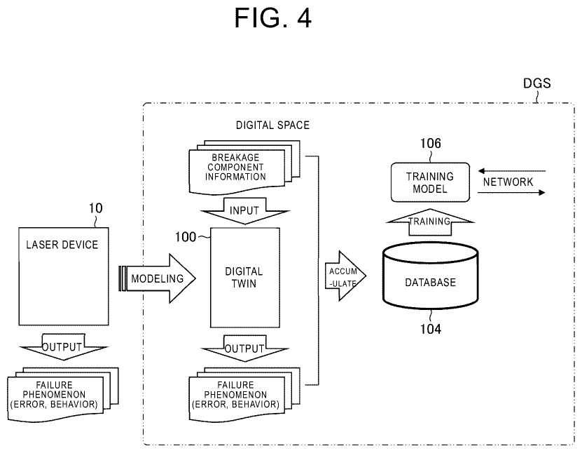

FIG. 4 is an explanatory diagram showing an outline of a system that implements a method of creating a training model 106 according to a first embodiment. A Digital Twin 100 is constructed by modeling, in a digital space DGS such as a server or a cloud, electrical hardware including various sensors of the laser device 10 and software. The Digital Twin 100 is a digital copy of the laser device 10. The Digital Twin 100 may include a physical model of the electrical hardware, some components, and the like of the laser device 10. The Digital Twin 100 is configured to output an error code or a state quantity as a failure phenomenon in a similar manner as the laser device 10 in the real space when information (hereinafter, referred to as breakage component information) indicating that a certain component has been broken (malfunctioned) is input.

Information obtained by sequentially breaking components in the laser device 10 one by one or in combination of a plurality of components is input to the Digital Twin 100 to output a failure phenomenon, and breakage components and failure phenomena (behavior of the laser device 10 such as an error code and a state quantity) as a result are associated with each other and accumulated in the database 104. The concept of a “component” when the components in the laser device 10 are sequentially broken includes a wiring of a transmission system such as a signal line a power supply line. “Breaking” includes disconnection of a wiring of the transmission system. The expression “breaking” or “breakage” of a component includes the concept of “being malfunctioned” or “malfunction.”

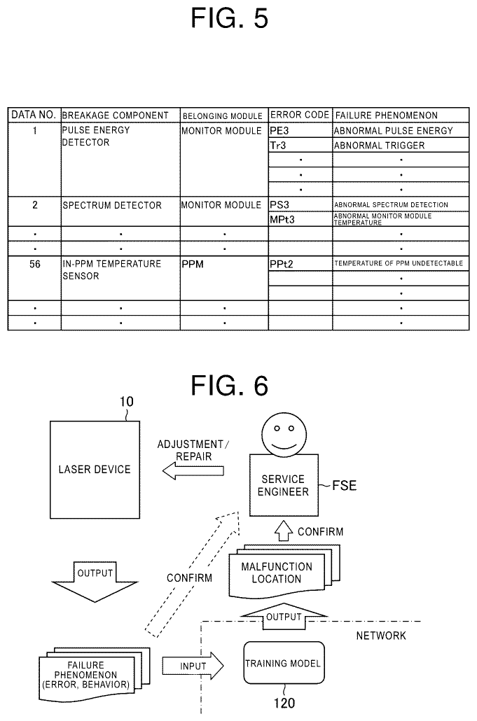

Breakage component information input to the Digital Twin 100 may be automatically generated by a program. By breaking, on the Digital Twin 100, components in the laser device 10 one by one or by combining a plurality of components and changing the combination to break, data of failure phenomena corresponding to breakage components are obtained from the Digital Twin 100. Data accumulated in the database 104 may be, for example, as shown in FIG. 5.

FIG. 5 is a table showing an example of data accumulated in the database 104. The breakage component may be data associated with a module or an assembly to which the breakage component belongs. An assembly is a unit in which a plurality of components are combined. The item “belonging module” shown in FIG. 5 may be an assembly to which the breakage component belongs. The “belonging module” is a component assembly serving s a replacement unit for component replacement at the time of maintenance, and includes concepts such as an assembly, equipment, and a detector serving as a replacement unit.

Data accumulated in the database 104 is used as training data for machine learning. That is, the training model 106 is trained by performing machine learning using the data (data created by the Digital Twin 100) accumulated in the database 104, and the training model 106 is created so as to output a malfunction location upon receiving an input of a failure phenomenon.

The training model 106 may output a module, an assembly, or the like to which a malfunction location belongs together with the output of the malfunction location. The training model 106 may be configured of an artificial intelligence (AI) using an expert system, a Bayesian network, or the like, or may use a neural network.

The database 104 and the training model 106 are configured to be accessible on the digital space DGS from a network. The network may be a wide area network such as the Internet.

The Digital Twin 100 and the database 104 may be constructed for each laser model of the laser device 10. A training model for each laser model may be created using the database 104 constructed for each laser model of the laser device 10. The training model 106 may be trained by databases of a plurality of laser models as well.

The digital space DGS is realized using a computer system including one or more processors (not shown) and one or more storage devices (not shown). The storage device is a non-transitory tangible computer-readable medium, and includes, for example, a memory as a main storage device and a storage as an auxiliary storage device. A computer that realizes the functions of the Digital Twin 100, a computer that stores and manages the database 104, and a computer that realizes processing functions of machine learning for training the training model 106 may each be configured by separate hardware, or a computer that realizes some or all of these processing functions may be configured by common hardware.

### 2.2 Operation

### 2.2.1 Generation of Training Data and Training Phase

The Digital Twin 100 functions as a simulation model that can virtually reproduce, in the digital space DGS, behavior of the laser device 10 in the real space. By using the Digital Twin 100, it is possible to artificially create data of a failure phenomenon in which it is difficult to actually collect data from the laser device 10 in the real space, a failure phenomenon in which it takes a lot of time to actually collect data, and an extremely rare or unexpected failure phenomenon that has not been recorded in the past.

Thus, by performing supervised learning using a data set generated using the Digital Twin 100 as training data, the training model 106 trained to output a malfunction location in response to an input of a failure phenomenon is obtained. The input to the training model 106 in a training phase may include an error code indicating a failure phenomenon. The input to the training model 106 may also include an output value of a sensor. The training model 106 performs a class classification process of estimating a malfunction location based on input failure information, and outputs an estimation result (classification result). The output from the training model 106 may be a classification score indicating a certainty factor of a malfunction location.

A breakage component associated with a failure phenomenon in the training data is used as correct answer data of a malfunction location corresponding to a failure phenomenon used as the input. As the output from the training model 106, an estimation result of a module or an assembly to which a malfunction location belongs may be output together with the malfunction location or in place of the malfunction location. In this case, a module to which a broken component associated with a failure phenomenon in the training data belongs is used as correct answer data of a module or an assembly to which a malfunction location corresponding to a failure phenomenon used in the input belongs.

By training the training model 106 using a large number of data accumulated in the database 104, parameters of the training model 106 may be updated to appropriate values, and the training model 106 may obtain a target inference performance. The trained training model 106 thus created may be utilized as a tool in place of the failure list 88 described in FIG. 3.

### 2.2.2 Inference Phase

FIG. 6 is an explanatory diagram schematically showing an example of a method of using a trained model created by implementing a method of creating a training model 120 according to the first embodiment. The training model 120 shown in FIG. 6 is a trained model trained by the method described in FIG. 4 to obtain a reasonable inference performance.

The training model 120 is incorporated in a computer such as a server accessible via the network. When the laser device 10 outputs information on a failure phenomenon (hereinafter, referred to as failure information), the failure information is input to the training model 120 via the network. At this time, the laser device 10 may be connected to the network. Alternatively, the service engineer FSE may input the failure information to the training model 120 via the network using a terminal (not shown) connectable to the network. The terminal operated by the service engineer FSE may be a notebook personal computer, a tablet terminal, or the like.

The training model 120 provides an estimation list of a malfunction location from the failure information to the service engineer FSE at the site via the network. At this time, the estimation list may be displayed on the display 84 of the laser device 10 or may be displayed on a display of the terminal carried by the service engineer FSE. At this time, at least one malfunction location estimated by the training model 120 is displayed. In addition, a module to which the malfunction location belongs may be displayed.

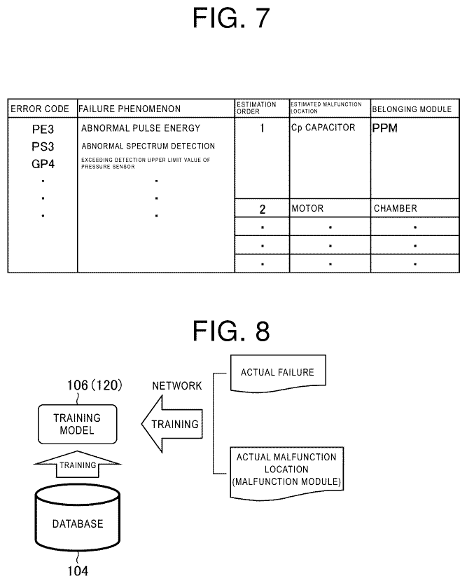

FIG. 7 is a table showing an example of the estimation list of the malfunction location estimated using the training model 120. The display order in the estimation list may prioritize modules including more malfunction locations (see FIG. 7). That is, the estimation list is configured such that a module including a larger number of malfunction locations can be displayed with a higher priority. The “estimation order” in FIG. 7 corresponds to the priority order of the display. The service engineer FSE can quickly perform component replacement or adjustment operation by referring to the estimation list. If the estimation list is provided before the service engineer FSE goes to the site, the service engineer FSE can go to the site with a replacement component prepared in advance.

### 2.3 Effect

According to the method of the first embodiment, since the training model 120 provides the estimation list, it is possible to greatly shorten operation required for identifying a malfunction location. Further, it is possible to grasp in advance failure phenomena when every assumable component is broken on the Digital Twin 100. Therefore, it is possible to immediately take an appropriate countermeasure for an error that has never occurred in the past or a failure that occurs at a very low frequency in the actual laser device 10.

The method (creating method) of creating the training models 106, 120 described in the first embodiment can be understood as a method (manufacturing method) of producing the training models 106, 120 and a method of manufacturing a computer-readable medium in which the training models 106, 120 are recorded.

### 3. Second Embodiment

### 3.1 Configuration

FIG. 8 is an explanatory diagram showing an outline of a method of creating the training model 106 according to a second embodiment. The database 104 shown in FIG. 8 accumulates artificial failure data created using the Digital Twin 100 as described in FIG. 4. Here, the Digital Twin 100 is omitted in FIG. 8. FIG. 8 will be described in terms of differences from FIG. 4.

In addition to training using data in the database 104, the training model 106 may be trained using data (actual data based on actual examples) indicating a correspondence relationship between an actual failure phenomenon obtained from the actual laser device 10 and a corresponding actual malfunction location. It is preferable that information on the actual malfunction location includes information on a module (malfunction module) to which the malfunction location belongs. Such data based on a failure phenomenon actually confirmed in the laser device 10 may be provided to the training model 106 via the network.

Data in which an actual failure phenomenon and an actual malfunction location are associated with each other is not limited to data obtained from a failure phenomenon that occurred in the operation site of the laser device 10, and may be data obtained from a failure phenomenon that occurred in experiment in a development department or the like, and may include data of a failure list accumulated as failure cases of a laser model of a same type. Other system configurations may be similar to those of FIG. 4.

### 3.2 Operation

As a method of utilizing actual data as training data, for example, there is a method of training the training model 106 using data in the database 104 to create the training model 120 in which inference performance of an allowable practical level is obtained, and then further performing additional training on the training model 120 using actual data as additional training data to enhance the inference performance. In this case, while the training model 120 already having an inference performance of a practical level is utilized at the service site, performance of the training model 120 can be further improved based on actual data obtained from the laser device 10 at the site, and the training model 120 can be updated.

Another method is to train the training model 106 using actual data as training data together with data in the database 104 in the course of training in achieving the inference performance of a target practical level.

### 3.3 Effect

According to the method of the second embodiment, inference of the training model 120 can be gradually improved by sequentially inputting actual data based on actual examples into the training model 120.

Further, according to the method of the second embodiment, it is possible to improve the inference accuracy of the training models 106, 120 by training the training models 106, 120 using actual data based on actual examples in addition to data artificially created using the Digital Twin 100.

### 4. Third Embodiment

### 4.1 Configuration

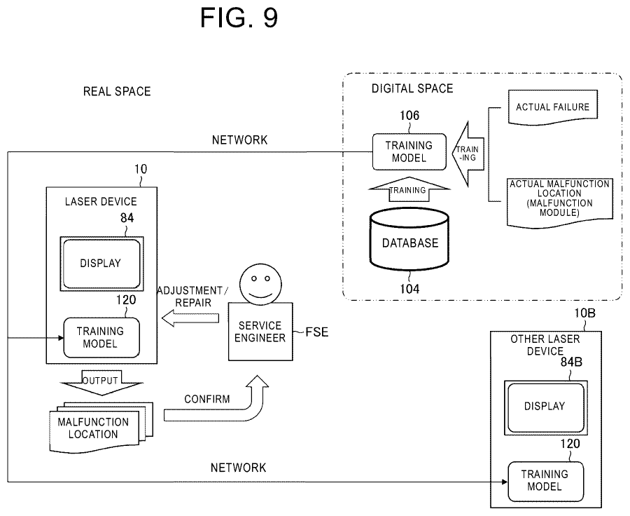

FIG. 9 is an explanatory diagram showing laser devices 10, 10B each including the training model 120 according to a third embodiment and an outline of an application example thereof. In the configuration shown in FIG. 9, components common to those in FIGS. 4 and 8 are denoted by the same reference numerals. The training model 120 trained using the data in the database 104 may be mounted on the laser device 10. The training model 120 may be mounted on the laser device 10B other than the laser device 10. When the training model 120 is created for each laser model, the laser devices 10, 10B are the same laser model. When the training model 120 is created as a universal model that can perform inference for a plurality of laser models, the laser devices 10, 10B may be different laser models. The laser device 10B includes a display 84B for displaying various types of information.

The laser devices 10, 10B may be shipped with the training model 120 mounted thereon, or the training model 120 may be downloaded into the devices via the network after shipment and installation. The training model 120 may be integrated into software in the laser devices 10, 10B.

The training model 120 may be trained in the digital space DGS such as a server or a cloud as in the first or second embodiment.

### 4.2 Operation

The training model 120 in the laser device 10 may be accessibly connected to a control unit, software, a memory, or the like of the laser device 10, and may receive data related to a failure phenomenon from the processor 26.

When the training model 120 in the laser device 10 receives data related to a failure phenomenon, the training model 120 presents an estimation list (see FIG. 5) including the estimation result of a failure cause and a malfunction location to the service engineer FSE at the site in a manner such as displaying the estimation list on the display 84, similarly to the first embodiment. Alternatively, the laser device 10 may transmit an estimation list of a failure cause and a malfunction location to a terminal of a laser device manufacturer or the service engineer FSE via the network, or may output the estimation list to a fault detection and classification (FDC) system. The same applies to operation of the training model 120 in the other laser device 10B.

The training model 120 may be updated via the network as appropriate. For example, data of a malfunction location corresponding to a failure phenomenon that has actually occurred may be collected from the laser devices 10, 10B at any time, and the training model 120 may be updated by the training model 106 that is trained on the digital space DGS at any time using the collected actual data as additional training data. The model may be updated periodically, or an operator may specify the update timing.

### 4.3 Effect

According to the configuration of the third embodiment, since the service engineer FSE can quickly obtain a solution at the site or in advance, it is possible to further shorten the time required for troubleshooting. Since it is possible to estimate a malfunction location even in a single laser device, an appropriate countermeasure can be immediately presented even when, for example, a failure occurs in a communication function or the condition of a communication line is poor. Further, by performing additional training on the training model 106 using actual data, it is possible to further improve the inference accuracy of the training model 120, and the training model 120 can be kept in the latest state via the network.

### 5. Other Examples of Laser Device

FIG. 1 shows an example of a line narrowing KrF excimer laser device, but the present invention is not limited to this example, and may be a line narrowing ArF excimer laser device. Although FIG. 1 shows an example of the single chamber laser device 10, the present invention is not limited to this example, and may be a laser device including a master oscillator that outputs line-narrowed pulse laser light and an amplifier that amplifies the pulse laser light output from the master oscillator by a chamber including an excimer laser gas.

Further, in the laser device including the master oscillator and the amplifier, the master oscillator may be a solid-state laser device in which a solid-state laser and a nonlinear crystal are combined and which outputs laser light line-narrowed in an amplifiable wavelength range of an ArF laser or a KrF laser.

### 6. Functional Role of Information Processing System

As described with reference to FIG. 4, the information processing system that artificially generates data related to various failure phenomena using the Digital Twin 100 can function as a data generation device that automatically generates failure data. In addition, the information processing system can function as a database creation device in that the automatically generated data can be converted into a database to create the database 104. The database 104 created using the Digital Twin 100 may be a failure data group covering all failure phenomena that can occur in the laser device 10. Even if all of the failure phenomena cannot be strictly covered, it is preferable that the failure data group covers almost all of the expected failure phenomena.

In addition to the role of providing training data to the training model 106, the database 104 may also be used, for example, to accept input of a search key and return a search result of data in the database 104.

As described with reference to FIGS. 4 and 8, a machine learning system (machine learning device) that performs machine learning using data in the database 104 as training data and trains the training model 106 functions as a training model creation device. The information processing system that estimates a malfunction location from a failure phenomenon using the trained training model 120 functions as a malfunction location estimation device. Further, the information processing system that estimates, from a failure phenomenon, a module that is a replacement component to which a malfunction location belongs using the training model 120 functions as a replacement component estimation device or a failure countermeasure support device. The training model 120 is not limited to being incorporated in the laser devices 10, 10B, a terminal carried by a service engineer FSE, and the like, and may be applied as a Software as a Service (Saas) that is deployed in a cloud server or the like, accepts an input of information on a failure phenomenon via the network, and returns an estimation result of a malfunction location.

Further, it is also possible to distribute a program that causes a computer to realize a part or all of the processing functions as the data generation device, the machine learning device, the replacement component estimation device, and the failure countermeasure support device by recording the program in a non-transitory tangible computer-readable medium.

### 7. Electronic Device Manufacturing Method

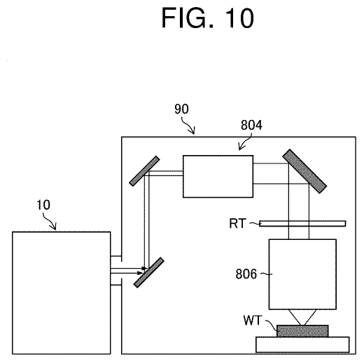

FIG. 10 schematically shows a configuration example of the exposure apparatus 90. The exposure apparatus 90 includes an illumination optical system 804 and a projection optical system 806. As described with reference to FIG. 8, the laser device 10 may be configured to include the training model 120. The laser device 10 generates pulse laser light and outputs the pulse laser light to the exposure apparatus 90. The illumination optical system 804 illuminates a reticle pattern of a reticle (not shown) arranged on a reticle stage RT with laser light incident from the laser device 10. The projection optical system 806 causes the laser light transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 90 synchronously translates the reticle stage RT and the workpiece table WT to expose the workpiece to the laser light reflecting the reticle pattern. After the reticle pattern is transferred onto the semiconductor wafer by the exposure process described above, a semiconductor device can be manufactured through a plurality of processes. The semiconductor device is an example of the “electronic device” in the present disclosure. In place of the laser device 10, the other laser device 10B shown in FIG. 9, a line narrowing ArF excimer laser device, or a laser device including a master oscillator and an amplifier may be used.

### 8. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A training model creating method comprising:
creating a database by breaking a component in a laser device on a Digital Twin constructed by modeling electrical hardware and software of the laser device, and accumulating data in which the broken component and a failure phenomenon output from the Digital Twin are associated with each other; and
training a training model using the data in the database as training data for machine learning so that, upon receiving an input of information on a failure phenomenon, the training model outputs information on a malfunction location corresponding to the input.

2. The training model creating method according to claim 1,
wherein the electrical hardware includes a processor, a monitoring target including a sensor, a state of which is to be monitored by the processor, and equipment including a wiring for connecting the processor and the monitoring target.

3. The training model creating method according to claim 1,
wherein the Digital Twin outputs information on at least one of an error code and a state quantity as the failure phenomenon when information indicating that, among components in the laser device, one thereof or a plurality thereof in combination are broken is input.

4. The training model creating method according to claim 1,
wherein, by breaking components in the laser device one by one on the Digital Twin, the data in which the broken components and the failure phenomena output from the Digital Twin are associated with each other is accumulated in the database.

5. The training model creating method according to claim 1,
wherein, by breaking a plurality of components in the laser device in combination on the Digital Twin while changing a combination of the plurality of components to be broken, the data in which the broken components and the failure phenomena output from the Digital Twin are associated with each other is accumulated in the database.

6. The training model creating method according to claim 1,
wherein the data accumulated in the database includes information on a module to which the broken component belongs.

7. The training model creating method according to claim 6,
wherein information on the malfunction location output from the training model includes information on a module to which the malfunction location belongs.

8. The training model creating method according to claim 6,
wherein the training model outputs an estimation list including information on a module to which the malfunction location estimated from the input information on the failure phenomenon belongs, and the estimation list is configured to be capable of being displayed such that the module including a larger number of the malfunction locations has a higher priority.

9. The training model creating method according to claim 1,
wherein the Digital Twin and the database are constructed for each laser model of the laser device.

10. The training model creating method according to claim 9,
wherein the training model is trained using data included in the database of a plurality of laser models constructed respectively for the laser models.

11. The training model creating method according to claim 1, further comprising:
training the training model using actual data in which an actual malfunction location and a failure phenomenon having occurred in the laser device are associated with each other.

12. The training model creating method according to claim 11, further comprising:
performing additional training on the training model using the actual data as additional training data.

13. The training model creating method according to claim 12,
wherein the actual data is acquired via a network to perform the additional training.

14. The training model creating method according to claim 12, further comprising:
updating the training model by performing the additional training using the actual data and providing the updated training model via a network.

15. The training model creating method according to claim 11,
wherein the training model is trained using the actual data obtained from a plurality of laser devices as training data.

16. The training model creating method according to claim 15,
wherein additional training is performed on the training model using the actual data obtained from the plurality of laser devices as additional training data, and updating the training model.

17. The training model creating method according to claim 1, further comprising:
mounting, on a laser device, the training model trained using data in the database.

18. A laser device comprising:
an electrical hardware including a processor, a monitoring target including a sensor, a state of which is to be monitored by the processor, and equipment including a wiring for connecting the processor and the monitoring target; and
a training model trained by machine learning to output, upon receiving an input of information on a failure phenomenon, information on a malfunction location corresponding to the input,
the training model being a model trained using data, as training data, in a database created by breaking a component in the laser device on a Digital Twin constructed by modeling the electrical hardware and software of the laser device and accumulating the data in which the broken component and a failure phenomenon output from the Digital Twin are associated with each other.

19. An electronic device manufacturing method, comprising:
generating laser light using a laser device;
outputting the laser light to an exposure apparatus; and
exposing a photosensitive substrate to the laser light in the exposure apparatus to manufacture an electronic device,
the laser device including:
an electrical hardware including a processor, a monitoring target including a sensor, a state of which is to be monitored by the processor, and equipment including a wiring for connecting the processor and the monitoring target; and
a training model trained by machine learning to output, upon receiving an input of information on a failure phenomenon, information on a malfunction location corresponding to the input,
the training model being a model trained using data, as training data, in a database created by breaking a component in the laser device on a Digital Twin constructed by modeling the electrical hardware and software of the laser device and accumulating the data in which the broken component and a failure phenomenon output from the Digital Twin are associated with each other.
